(19) United States
(12) Patent Application Publication
(10) Pub. No.: US 2026/0140544 A1
(43) Pub. Date: May 21, 2026

(54) AUTOMATION FIELD DEVICE

(71) Applicant: Endress+Hauser SE+Co. KG, Maulburg (DE)

(72) Inventors: Florian Asal, Aitern (DE); Jürgen Meier, Maulburg (DE); Christian Strittmatter, Rickenbach (DE); Jürgen Tanner, Kandern (DE)

(21) Appl. No.: 19/125,114

(22) PCT Filed: Sep. 18, 2023
(86) PCT No.: PCT/EP2023/075666

§ 371 Date: Apr. 28, 2025

(30) Foreign Application Priority Data
Oct. 27, 2022 (DE) 10 2022 128 537.5

(51) Int. Cl. G06F 1/16

(52) U.S. Cl. CPC G06F 1/1675; G06F 2200/1614

(57) ABSTRACT

A field device of automation technology includes a field device housing having an inner space, and an interaction—and/or display element having a shaped screen, such as a round, rectangular or square screen. Also included is a mechanically actuatable system, which is adapted, sometimes even in an electrically unpowered state of the field device, mechanically to specify a desired orientation of an image to be shown on the screen of the interaction—and/or display element. An electronic circuit is arranged in the inner space and is adapted, such as in an electrically powered state of the field device, to detect an orientation of the image specified by the mechanically actuatable system and to drive the interaction—and/or display element in such a manner that the image on the screen corresponds to the mechanically specified orientation.

The invention relates to a field device of automation technology as well as to a method for servicing such a field device.

In process—and manufacturing automation technology, field devices are often applied, which serve for registering and/or influencing process variables. Serving for registering process variables are sensors, such as, for example, fill level measuring devices, flow measuring devices, pressure—and temperature measuring devices, pH-redox potential measuring devices, conductivity measuring devices, etc., which register the corresponding process variables, fill level, flow, pressure, temperature, pH value, and conductivity. Serving for influencing process variables are actuators, such as, for example, valves or pumps, via which the flow of a liquid in a pipeline section, or the fill level in a container, can be changed.

Referred to as field devices are, in principle, all devices, which are applied near to a process and which deliver, or process, process relevant information. Besides the above mentioned sensors and actuators, referred to as field devices are generally also such units, which are connected directly to a fieldbus and serve for communication with superordinated units, i.e. units such as e.g. remote I/Os, gateways, linking devices and wireless adapters.

A large number of such field devices are manufactured and sold by the Endress+Hauser group of companies.

In order, for example, to make settings in a field device and/or retrieve current measured values, such field devices have an interaction—and/or display element. Such must be oriented, depending on installed position of the field device. In some situations, it is necessary that the orientation occurs mechanically, e.g. when electrical power has not yet been supplied to the field device. Therefore, currently the interaction—and/or display elements are formed on a separate circuit board or card and electrically connected with an electronics of the field device formed on at least one additional circuit board. The electrical connection between the circuit board with the interaction—and/or display element and the electronics of the field device occurs, in such case, usually via a plug, cable, sliding contact, or the like.

Disadvantageous in such construction is that at least two circuit boards are used and furthermore also that the circuit boards must be connected together electrically via corresponding connecting technology. Both of these disadvantages lead to relatively high costs during the manufacturing of the field device.

An object of the invention, thus, is to provide an easy and, especially, cost effective variant for enabling orientation of the interaction—and/or display element.

The object is achieved according to the invention by the field device of automation technology as defined in claim 1 and the method as defined in claim 10.

The automation field device of the invention comprises:
a field device housing having an inner space;
an interaction—and/or display element having a preferably round, rectangular or square screen;
a mechanically actuatable system, which is adapted, preferably even in an electrically unpowered state of the field device, mechanically to specify a desired orientation of an image to be shown on the screen of the interaction—and/or display element;
arranged in the inner space, an electronic circuit, which is adapted, preferably in an electrically powered state of the field device, to detect an orientation of the image specified by the mechanically actuatable system and to drive the interaction—and/or display element in such a manner that the image shown on the screen corresponds to the mechanically specified orientation.

According to the invention, a field device of automation technology is provided in the case of which, by means of a mechanically actuatable system, such as, for example, a cap, and based on the orientation of the screen specified by the mechanically actuatable system, and wherein the actuation can occur especially even in an electrically unpowered state, a digital rotation of the screen is possible in the actual operating state of the field device.

The electrically unpowered state refers, in such case, to the state, in the case of which the field device is not supplied from an external electrical power source, such as, for example, a measurement transmitter electrical power supply device or a 4-20 mA two-conductor line. Usually, such state is present in the commissioning of the field device, when the field device has been mounted at the intended measuring point and, in given cases, also electrically contacted, but, at this point in time, no external electrical power supply is occurring. The electrically unpowered state can, for example, however, also be a turned-off state of the field device, in the case of which the field device has already been taken completely into operation, but, at the moment, is not turned on.

An advantageous embodiment of the automation field device of the invention can provide that the mechanically actuatable system is embodied in such a manner that it enables a plurality of different, preferably discrete, especially preferably at least two, especially preferably four, quite especially preferably exactly four, mechanically set positions, wherein each set position corresponds to a certain desired orientation of the image on the screen of the interaction—and/or display element.

Another advantageous embodiment of the automation field device of the invention can provide that the mechanically actuatable system includes a cap, which is embodied in such a manner that it is placeable over at least a part of the electronic circuit, especially pluggable on top, and has a, preferably round, rectangular or square, opening, which is embodied in such a manner that it can accommodate at least the part of the interaction—and/or display element with the screen and wherein the mechanically actuatable system is further adapted such that, by placing of the cap over the at least one part of the electronic circuit in different placed positions, the mechanically specified, desired orientation of the image on the screen of the interaction—and/or display element can be set. Especially, the embodiment can provide that the field device further includes an electronics pot having a pot opening and arranged in the inner space of the field device, wherein the electronic circuit and the interaction—and/or display element are arranged, at least partially, in the electronics pot and the interaction—and/or display element is arranged in the electronics pot in such a manner that the screen faces toward the pot opening, wherein the cap is embodied in such a manner that it is placeable on an edge of the electronics pot forming the pot opening, especially pluggable on, or placed, especially plugged on.

An alternative embodiment of the automation field device of the invention can provide that the mechanically actuatable system comprises a potentiometer, a mechanical selector switch, a joystick, or the like.

Another advantageous embodiment of the automation field device of the invention can provide that the screen of the interaction—and/or display element is, at least sectionally, touch sensitive.

Another advantageous embodiment of the automation field device of the invention can provide that the field device further comprises a sensor—and/or actuator element for registering and/or setting at least one process variable, wherein the electronic circuit is further adapted to operate the sensor—and/or actuator element. Especially, the embodiment can provide that the electronic circuit comprises not more than two circuit boards, preferably exactly one circuit board, both for operating the sensor—and/or actuator element as well as also for driving the interaction—and/or display element.

Another advantageous embodiment of the automation field device of the invention can provide that the electronic circuit is adapted to detect the orientation of the image specified by the mechanically actuatable system capacitively or electromechanically, especially by a switch, a button, a shortcircuiting or the like.

The invention relates further to a method for servicing a field device of automation technology as defined in one of the above described embodiments, comprising steps as follows:
actuating the mechanically actuatable system by an operator in such a manner that the operator mechanically specifies a desired orientation of the image to be shown;
turning the field device on, such that the electronic circuit is in an electrically powered state;
detecting the orientation of the image specified by the mechanically actuatable system, wherein this step is performed by the electronic circuit;
showing the image on the screen of the interaction—and/or display element in accordance with the orientation of the image specified by the mechanically actuatable system.

An advantageous form of embodiment of the method of the invention can provide that the actuating of the mechanically actuatable system occurs in an electrically unpowered state of the field device, in the case of which the field device is not connected to an electrical current-, or voltage, source, especially a measurement transmitter electrical power supply device.

Another advantageous form of embodiment of the method of the invention can provide that, after the actuating of the mechanically actuatable system by the operator, the field device is connected to an electrical current-, or voltage, source.

The invention will now be explained in greater detail based on the appended drawing, the figures of which show as follows:

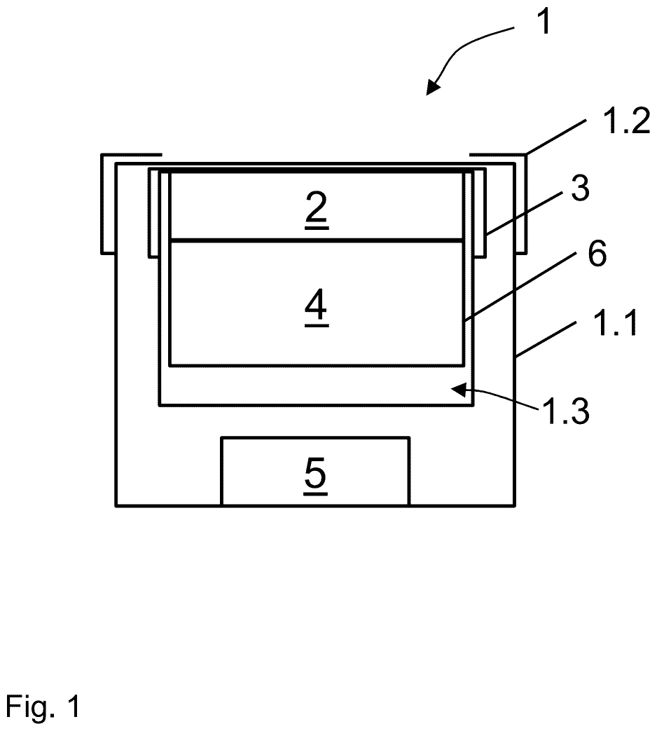

FIG. 1 a schematic view of a field device of automation technology, and

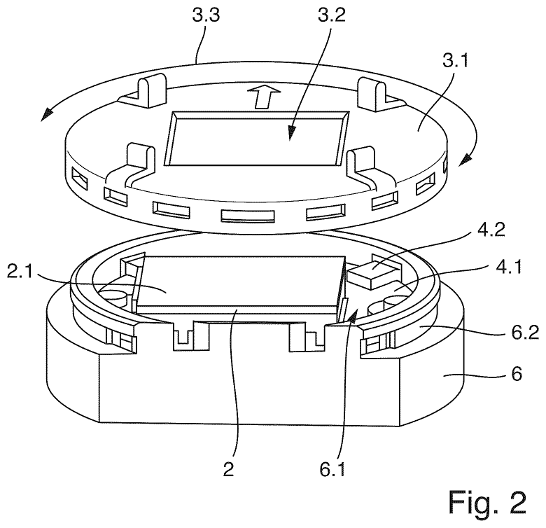

FIG. 2 a mechanically actuatable system embodied according to the invention in the electrically unpowered state of the field device for specifying an orientation of a screen of the interaction—and/or display element.

FIG. 1 basically shows a usual construction of a field device of automation technology 1. The field device includes a housing 1.1, which encloses an inner space 1.3. Usually, the housing includes a housing lid 1.2, which is secured on or to a housing base 1.4, e.g. by screwing. The field device 1 further includes a sensor—and/or actuator element 5 arranged on the housing 1.1 for setting and/or registering a process variable as well as an electronic circuit 4 in the inner space 1.3 for operating the sensor—and/or actuator element 5.

In order to enable a servicing/parametering of the field device and/or in order to display information, e.g. with reference to the process variable to be registered or set, the field device 1 includes an interaction—and/or display element 2. The interaction—and/or display element 2 can, such as shown in FIG. 1, be mounted in a housing wall of the field device, preferably in the housing lid 1.2 of the field device. Alternatively, the interaction—and/or display element 2 can also be secured on an outside of the housing wall. The interaction—and/or display element 2 has e.g. a rectangular screen for viewing information in the form of an image. Alternatively, the screen can also be round. The screen 2.1 of the interaction—and/or display element 2 can, at least sectionally, be touch sensitive. The electronic circuit 4 is further adapted to drive a screen 2.1 of the interaction—and/or display element 2, such that the desired information is shown on the screen. This means that the electronic circuit can be adapted both to operate the sensor—and/or actuator element as well as also to drive the interaction—and/or display element. Preferably, the electronic circuit is formed in such a manner that it is composed of exactly one circuit board populated with corresponding components, including the interaction—and/or display element, such that two circuit boards do not need to be used, such as usual in the state of the art.

FIG. 2 shows a mechanically actuatable system of the invention for specifying an orientation of a screen of the interaction—and/or display element when the field device is without electrical power. In order to be able mechanically to bring about a desired orientation of the image shown on the screen of the interaction—and/or display element, the mechanically actuatable system is embodied in such a manner that it enables a plurality of different discrete mechanically achievable set positions. Such can be implemented in different ways.

In the concrete example of an embodiment illustrated in FIG. 2, the mechanically actuatable system includes a mechanically coded, round cap, for instance providing a display frame, and an electronics pot. The electronics pot serves for accommodating the electronic circuit and/or the interaction—and/or display element and is placed in the inner space of the field device housing. The interaction—and/or display element is, in such case, oriented in such a manner in the electronics pot that the screen 2.1 of the interaction—and/or display element faces toward the pot opening 6.1. The cap is embodied in such a manner that it can be plugged onto a pot opening of the electronics pot. Alternatively, the mechanically actuatable system can also be embodied in the form of a mechanically operable potentiometer, a mechanically operable selector switch, a mechanically operable joystick, or the like.

In the example of an embodiment shown in FIG. 2, the mechanically actuatable system 3 is embodied in such a manner that four discrete, mechanically settable positions are possible. For this, the cap is embodied such that it can be rotated in 90° steps and can be placed at the corresponding set positions (0°, 90°, 180°; 270°) on the opening of the electronics pot, especially it can be plugged on. The cap is, thus, rotated about a rotation axis of the screen. Each of the mechanically selectable set positions represents, in such case, a particular desired orientation of the image on the screen. The example of an embodiment shown in FIG. 2 shows four discrete, mechanically settable positions. The invention, is, however, fundamentally also applicable for any other number of discrete, mechanically settable positions.

For registering the different settable positions, the cap can be encoded. For example, it can have on a side toward the opening (lower side) a coding element, for example, in the form of a nose or the like, which can be registered at the different positions electromechanically, for example, by an electrical switch, button or a shortcircuiting caused by the nose. Alternatively, the registering the nose can also occur using a capacitive evaluation unit, in the case of which the presence of the nose is sensed capacitively. The rotation of the cap occurs preferably when the field device is without electrical power, thus, for example, at the mounting/commissioning of the field device at the desired measuring point, e.g. on/at a tank.

Furthermore, the cap has a rectangular opening corresponding to the geometric shape of the screen of the interaction—and/or display element 2 and serving for receiving the screen in the plugged-on state. This means that the opening is sized in such a manner that at least the part of the interaction—and/or display element 2 with the screen 2.1 is not covered when the cap is arranged at the opening of the electronics pot. In the case, in which the interaction—and/or display element has a round screen, of course, also the cap has a round opening.

For placing the cap on the opening of the electronics pot, the cap 3.1 can be embodied in such a manner that it can be mounted on an edge of the electronics pot 6.2 forming the pot opening 6.1. Such can occur, for example, using a correspondingly formed catch mechanism, in the case of which an inwardly directed ridge of the cap engages with an outwardly facing groove of the electronics pot.

The field device of the invention with a mechanically actuatable system for specifying an orientation of a screen of the interaction—and/or display element allows that the orientation of the image on the screen can be set in the electrically unpowered state of the field device before the actual device start. At device start, thus, when the field device is supplied with electrical power, the mechanically specified orientation of the image is detected and the image shown on the screen is correspondingly oriented, e.g. rotated.

### LIST OF REFERENCE CHARACTERS

1 field device
1.1 field device housing
1.2 lid of the field device housing
1.3 inner space of the field device
2 interaction—and/or display element
2.1 screen
3 mechanically actuatable system
3.1 cap
3.2 opening of the cap
3.3 set position
4 electronic circuit
4.1 circuit board of the electronic circuit
4.2 switch, button, shortcircuiting, etc.
5 sensor—and/or actuator element
6 electronics pot
6.1 pot opening
6.2 edge of the electronics pot

1-12. (canceled)

13. A field device of automation technology includes:
a field device housing having an inner space;
an interaction—and/or display element having a preferably round, rectangular or square screen;
a mechanically actuatable system, which is adapted mechanically to specify a desired orientation of an image to be shown on the screen of the interaction—and/or display element;
arranged in the inner space, an electronic circuit, which is adapted to detect an orientation of the image specified by the mechanically actuatable system and to drive the interaction—and/or display element in such a manner that the image shown on the screen corresponds to the mechanically specified orientation.

14. The field device of claim 13, wherein:
the mechanically actuatable system is embodied in such a manner that it enables a plurality of different mechanically set positions, wherein each set position corresponds to a certain desired orientation of the image on the screen of the interaction—and/or display element.

15. The field device of claim 13, wherein:
wherein the mechanically actuatable system includes a cap, which is embodied in such a manner that it is placeable over at least a part of the electronic circuit, which is embodied in such a manner that it can accommodate at least the part of the interaction—and/or display element with the screen and wherein the mechanically actuatable system is further adapted such that, by placing of the cap over the at least one part of the electronic circuit in different placed positions, the mechanically specified, desired orientation of the image on the screen of the interaction—and/or display element can be set.

16. The field device of claim 13, further comprising:
an electronics pot having a pot opening and arranged in the inner space of the field device, wherein the electronic circuit and the interaction—and/or display element are arranged, at least partially, in the electronics pot and the interaction—and/or display element is arranged in the electronics pot in such a manner that the screen faces toward the pot opening, wherein the cap is embodied in such a manner that it is placeable on an edge of the electronics pot forming the pot opening.

17. The field device of claim 13, wherein:
the mechanically actuatable system comprises a potentiometer, a mechanical selector switch, a joystick, or the like.

18. The field device of claim 13, wherein:
the screen of the interaction—and/or display element is, at least sectionally, touch sensitive.

19. The field device of claim 13, further comprising:
a sensor—and/or actuator element for registering and/or setting at least one process variable, wherein the electronic circuit is further adapted to operate the sensor—and/or actuator element.

20. The field device of claim 19, wherein:
the electronic circuit comprises not more than two circuit boards, both for operating the sensor—and/or actuator element as well as also for driving the interaction—and/or display element.

21. The field device of claim 13, wherein:
the electronic circuit is adapted to detect the orientation of the image specified by the mechanically actuatable system capacitively or electromechanically.

22. A method for servicing a field device of automation technology as claimed in claim 1, comprising steps as follows:
actuating the mechanically actuatable system by an operator in such a manner that the operator mechanically specifies a desired orientation of the image to be shown;
turning the field device on, such that the electronic circuit is in an electrically powered state;
detecting the orientation of the image specified by the mechanically actuatable system, wherein this step is performed by the electronic circuit;
showing the image on the screen of the interaction—and/or display element in accordance with the orientation of the image specified by the mechanically actuatable system.

23. The method of claim 22, wherein:
the actuating of the mechanically actuatable system occurs in an electrically unpowered state of the field device, in the case of which the field device is not connected to an electrical current-, or voltage, source.

24. The method of claim 22,
wherein, after the actuating of the mechanically actuatable system by the operator, the field device is connected to an electrical current-, or voltage, source.
